(19) United States
(12) Patent Application Publication
(10) Pub. No.: US 2026/0050829 A1
(43) Pub. Date: Feb. 19, 2026

(54) TIME-SERIES FORECASTING AND IMPUTING USING AUTOMATED FEATURE EXTRACTION AND STATIC MACHINE LEARNING MODELS

(71) Applicant: ARTI ANALYTICS, INC., a Delaware Corporation, Morgan Hill, CA (US)

(72) Inventors: Tarik Hubana, Sarajevo (BA); Migdat Hodzic, San Jose, CA (US); Joerg Ferchau, Morgan Hill, CA (US)

(73) Assignee: ARTI ANALYTICS, INC., a Delaware Corporation, Morgan Hill, CA (US)

(21) Appl. No.: 19/045,394

(22) Filed: Feb. 4, 2025

Related U.S. Application Data
(60) Provisional application No. 63/684,797, filed on Aug. 19, 2024.

(51) Int. Cl. G06N 20/00

(52) U.S. Cl. CPC G06N 20/00

(57) ABSTRACT

Existing methods for time series forecasting are based on models specifically designed to handle temporal dependencies with domain expert assistance to engineer the features that the model will used for training. Disclosed herein is a method and process for time-series data forecasting and imputing using automated feature extraction algorithms and static machine learning models. The method and process disclosed herein includes algorithms for automated feature extraction from time series signals that contain single time-aware variable. The processes implemented in software described herein consists of an end-to-end pipeline for generation of machine learning training dataset, automated training procedure with static machine learning models, and deploying the model to make forecasts or impute missing time-series data. In essence, this pipeline enables non-domain experts to apply the model to time-series data regardless of data domain, by transferring the time-series problem from temporal domain to static (features) domain.

### CROSS-REFERENCE TO RELATED APPLICATIONS

This application claims the priority benefit of U.S. provisional patent application No. 63/684,797, filed Aug. 19, 2024, the entire contents of which are incorporated herein by reference.

### FIELD OF THE INVENTION

The present invention is related to machine learning models for time-series data.

### DESCRIPTION OF THE RELATED ART

Time-series data is a crucial aspect of various domains such as finance, meteorology, healthcare, and supply chain management, where the goal is often to predict future values in a dataset that has only one time-varying value. Traditional methods for handling time-series forecasting typically involve models like ARIMA (autoregressive integrated moving average), exponential smoothing, recurrent neural networks and LSTMs (long short-term memory) which are designed to capture temporal dependencies. These models often require significant domain expertise to manually engineer the features that the model will use for training. For example, ARIMA models are useful for stationary time series, where statistical properties such as mean and variance are constant over time. However, ARIMA requires manual identification of the order of the model, which can be complex and impractical for large datasets. LSTM networks, a type of recurrent neural network, are capable of learning long-term dependencies in data, making them suitable for complex time-series problems. Nevertheless, LSTMs require extensive computational resources and expertise in neural network architecture, which can be a barrier to their widespread adoption. Both ARIMA and LSTM models depend on carefully crafted features, and the process of feature extraction is a critical step that can significantly influence the model's performance. This manual feature engineering process is time-consuming, error-prone, and heavily reliant on the availability of domain experts. Therefore, despite advancements in time-series forecasting, these methods face challenges in terms of accessibility and ease of use, particularly for non-domain experts, hindering the broader application of time-series forecasting techniques across diverse fields where quick and accurate predictions are essential.

On the other hand, static regression model may be understood as a type of machine learning model that predicts a target variable based on input features without accounting for temporal sequences directly. One advantage of this arrangement is the simplicity and efficiency of training and deploying static models, as they do not require complex temporal dependencies management. Static models also generally require fewer computational resources, making them more accessible for users with limited hardware capabilities. Additionally, they are more versatile in handling diverse datasets, providing robust and accurate predictions across various domains. However, they cannot be used for time-series problems without creating an input features vector for each temporal target, which would again require manual feature engineering by domain experts.

### PRIOR ART

Multiple techniques and their applications have been developed to address the problem of time-series forecasting. Due to large importance, industry interest and limitations of conventional techniques for precise forecasting method that can be deployed in many domains, it is no surprise that many researchers and inventors contributed to the existing body of knowledge by utilizing various approaches to tackle the problem. What stands out as significant limitation of the prior art is the fact that both existing inventions and research body of knowledge are relying on complex domain specific models without unified approach that would work satisfactory across different domains.

The prior art in the field of time-series forecasting and analysis demonstrates a variety of methods and systems aimed at improving the accuracy, efficiency, and adaptability of predictive models, but limited to specific applications. This includes US patents U.S. Pat. Nos. 11,281,969; 8,010,324; 8,112,302; 9,087,306; 9,418,339; 9,244,887; 8,631,040; and 11,120,361; the entire contents of these applications are incorporated herein by reference.

Other prior art non-patent (research) publications include:
R. de A. Araujo, G. G. de M. Melo, A. L. I. de Oliveira, and S. C. B. Soares, ‘Morphological-Rank-Linear Models for Financial Time Series Forecasting’, New Achievements in Evolutionary Computation. InTech, Feb. 1, 2010. doi: 10.5772/8048.
R. Adhikari and R. K. Agrawal, ‘Effectiveness of PSO Based Neural Network for Seasonal Time Series Forecasting’, Proceedings of the Fifth Indian International Conference on Artificial Intelligence, 2011
I. Khandelwal, R. Adhikari, G. Verma, Time Series Forecasting Using Hybrid ARIMA and ANN Models Based on DWT Decomposition, Procedia Computer Science, Volume 48, 2015, pp 173-179
F. Zheng and S. Zhong, “Time series forecasting using an ensemble model incorporating ARIMA and ANN based on combined objectives,” 2011 2nd International Conference on Artificial Intelligence, Management Science and Electronic Commerce (AIMSEC), Deng Feng, China, 2011, pp. 2671-2674
G. P. Zhang, B. E. Patuwo, M. Y. Hu, A simulation study of artificial neural networks for nonlinear time-series forecasting, Computers & Operations Research, Volume 28, Issue 4, 2001, pp. 381-396
P. R. A. Firmino, P. S. G. de M. Neto, T. A. E. Ferreira, Error modeling approach to improve time series forecasters, Neurocomputing, Volume 153, 2015, pp 242-254
R. Adhikari, R. K. Agrawal, A linear hybrid methodology for improving accuracy of time series forecasting’, Neural Comput & Applic 25, 269-281, 2014.

The prior art on various artificial intelligence methods is summarized in Russell and Norvig, “Artificial Intelligence, A Modern Approach, Fourth Edition,” Pearson, 2021. See, in particular, chapters 14 and 21.

Prior art on various non-AI algorithms for analyzing time series data on standard computer processors includes “An Introduction to R Notes on R: A Programming Environment for Data Analysis and Graphics Version 4.4.2 (2024 Oct. 31),” by W. N. Venables, D. M. Smith, and the R Core Team.

Prior art on various methods to extract features suitable for machine learning systems include Feature Engineering and Selection, A Practical Approach for Predictive Models By Max Kuhn, Kjell Johnson, copyright 2020 by CRC Press.

### BRIEF SUMMARY OF THE INVENTION

The present invention was inspired, in part, by the insight that although the prior art presents various methods and their application in specific domains, none of them has approached the time-series forecasting problem in a unified manner, i.e. to automatically extract feature regardless of domain and provide good accuracy across multiple domains. Therefore, the system concept and architecture that includes automated specific feature extraction method, automated training, applicability across multiple domains and improved accuracy over the various algorithms presented in this invention proves to be more robust solution.

The present invention is also related to machine learning models for time-series data. More particularly, the invention relates to a method that automatically transforms single value time-series dataset into multiple values features dataset that can be used by static machine learning models with improved forecasting results by using the transformed time-series dataset.

Accordingly, the present invention relates to a novel method and process for time-series forecasting and imputing using automated feature extraction and static machine learning models. This invention addresses the limitations of traditional time-series forecasting methods, which typically require extensive domain expertise for manual feature engineering and significant computational resources for model training.

More specifically, a novel method and process for time-series forecasting and imputing using automated feature extraction and static machine learning models is disclosed. This method includes an algorithm for automated feature extraction from time-series signals containing a single time-aware variable. The process, implemented in software, offers an end-to-end pipeline for generating a machine learning training dataset, automating the training procedure with static machine learning models, and deploying the model for making forecasts or imputing missing time-series data. By transforming the time-series problem from the temporal domain to the static domain of features, this pipeline simplifies the process, enabling non-domain experts to apply the model to time-series data regardless of the data's domain.

One advantage of this arrangement is the significant reduction in time and effort required for feature engineering, allowing users automatically and effectively preprocess time-series data. This automated approach mitigates the risk of human error and ensures that the most relevant features are consistently extracted, leading to more accurate and reliable model predictions.

By combining automated feature extraction with static machine learning models, this invention addresses the key problems associated with traditional time-series forecasting methods, offering a user-friendly, efficient, and accurate solution for a wide range of applications.

As shown in FIG. 3, in some embodiments, the invention may be an automated method for time-series data analysis. This method may comprise using a time series-training dataset (300), at least one computer processor, and at least one static machine learning system to first automatically extract features from the time series dataset (302-318) and then using at least one static machine learning system to then automatically train at least one machine learning model, thus producing at least one trained machine learning model.

Here, the time-series training dataset typically (300) comprises a linear array of time points starting from an origin time point (301), each time point having a single associated data point (302) with a data point value (304).

For at least some later time points after the origin time point (301), the at least one computer processor uses at least one sliding time window (306) to create at least one data subset (e.g., the data points in 306), each at least one data subset comprising a portion of the linear array of time points (300) and their associated data points over that at least one sliding time window (306);

For each data subset (e.g. the data in a given sliding window 306), using a plurality of different algorithms and the at least one computer processor to extract features from that data subset, thus producing a plurality of data subset individual feature vectors (e.g. 308, 310, 314, 316, 318).

For each data subset (for a given sliding window 306), fusing this plurality of data subset feature individual vectors (308, 310, 312, 314, 316, 318) to produce a single data subset fused feature vector (320), (304). Thus, as the sliding window slides over the time series, this creates a plurality of such single data subset fused feature vectors.

This plurality of single data subset fused feature vectors, obtained over a plurality of different sliding time windows, is then used as a machine-learning dataset.

More specifically, the invention uses this machine-learning dataset and the at least one automated static machine-learning system, to automatically train at least one machine learning model, producing at least one trained machine learning model. The invention can then use this at least one trained machine learning model to implement a time-series forecasting system.

Put alternatively, the disclosed method includes an algorithm for automated feature extraction from time-series signals that contain a single time-aware variable, transforming the temporal data into a static feature domain (as shown in FIG. 2 and FIG. 3). This process is implemented in software, running in part (particularly for the feature extraction) on one or more standard computer processors, and running in part on more sophisticated machine learning training hardware (for the machine learning portion), and often resulting in a trained machine learning model such as the neural network). This provides an end-to-end pipeline that generates a machine learning training dataset, automates the training procedure with static machine learning models, and deploys the model for making forecasts or imputing missing data (as shown in FIG. 1).

In some embodiments, the at least one static machine learning system is selected from any of a Sklearn, ML.NET, TensorFlow, Keras, PyTorch, XGBoost, CatBoost or other deep learning system. See Russell and Norvig, “Artificial Intelligence, A Modern Approach” for other examples.

In some embodiments, using the machine-learning dataset and the static machine learning system to automatically train either the machine learning model for the time-series forecasting system by using any of genetic algorithms, grid search, ensemble models, stacking, linear regression, support vector regression, Bayesian regression, k-nearest neighbors, decision trees, gradient boosting algorithms, and neural networks to build this time-series forecasting system. Here, the static machine learning system can be configured to optimize either the machine learning model or the time-series forecasting system using any of a mean squared error (MSE) or other error metrics through any of iterative hyperparameter tuning and ensemble methods.

The invention simplifies the application of time-series forecasting by enabling non-domain experts to use the model effectively across various data domains (following the procedure shown in FIG. 2 and FIG. 3). By converting time-series problems from the temporal domain to the static feature domain, it leverages the efficiency and robustness of static machine learning models, which require fewer computational resources and offer broad applicability.

This innovative approach mitigates the need for manual feature engineering, reduces the risk of human error, ensures consistent extraction of relevant features, provides a generalized approach across multiple domains, resulting in more accurate and reliable predictions. The invention thus provides a user-friendly, efficient, and accessible solution for a wide range of time-series forecasting and imputing applications.

Thus, in some embodiments, the invention can comprise:
1. Automatic feature extraction from the time-series dataset (300) per each use case (as shown in FIG. 3).
2. Automatic dataset transfer from temporal to features domain (as shown in FIG. 2 and FIG. 3).
3. Automated machine learning procedure based on usage of static regression machine learning models that are more effective and advanced than the standard time-series models (as shown in FIG. 1).
4. Improved forecasting accuracy with static regression models compared to standard time-series models.
5. Elimination of domain-expertise for time-series machine learning problems.
6. Comprehensive end-to-end machine learning process flow implementation.
7. More efficient computational efficiency compared to standard time-series models.

Although the features themselves can often be extracted using standard algorithms, machine learning methods may also be used to determine which set of algorithms is best for any given time series dataset. This can be an iterative process, in which a machine learning system first selects a first set of feature analysis algorithms, uses this first set to extract features and train a first machine learning model, and then observes the predictive success of this first machine learning model, and then attempts to improve on this by selecting a second set of feature analysis algorithms and repeating the feature extraction and machine learning training process. This process can automatically repeat for as long as desired or until the predictive value of the trained machine learning value reaches a preset goal. This can be viewed as producing a trained automated feature extraction algorithm.

In some alternative embodiments, the invention may be a system and/or method for performing time-series data analysis. This method can comprise obtaining at least one time-series training dataset, automatically extracting features, and using this at least one time series-training dataset and at least one AI or machine learning method to train an automated feature extraction algorithm, thus producing a trained automated feature extraction algorithm. Then, according to the invention, obtaining at least one different (e.g. unknown) set of time-series data, and using this trained automated feature extraction algorithm to analyze this different set of time-series data, thus producing analyzed (unknown) time-series data.

### BRIEF DESCRIPTION OF THE DRAWINGS

For a further understanding of the objects and advantages of the present invention, reference should be had to the following detailed description, taken in conjunction with the accompanying drawing, in which like parts are given like reference numerals and wherein:

FIG. 1. is a block diagram depicting the method and process for time-series forecasting and imputing using automated feature extraction and static machine learning models in accordance with the present invention.

FIG. 2. is a block diagram depicting the automated feature extraction subroutine for method and process for time-series forecasting and imputing using automated feature extraction and static machine learning models in accordance with the present invention.

FIG. 3. is a block diagram depicting the feature vector generation subroutine for each data point in the automated feature extraction subroutine in accordance with the present invention.

FIG. 4. presents a flowchart diagram showing a representation of the transaction flow, application of logic and examples of technology applied at each step in accordance with the present invention.

### DETAILED DESCRIPTION OF THE INVENTION

Terminology: in this disclosure, the term “algorithm” will generally refer to various mathematical data analysis methods that can be performed with standard computer processors. This includes, but is not limited to, mathematical operations such as lagged values, moving averages, exponential moving averages, temporal differences, cumulative sums, time delta features, moving window replicated features, seasonality indicators, autocorrelation, local maxima, local minima, mean, median, standard deviation, variance, autocovariance, skewness, kurtosis, minimum values, maximum values, percentiles, interquartile ranges, energy, entropy, cross-entropy, time values, season values, binary indicators for events, time-frequency coefficients from Fourier and wavelet transforms, dominant frequencies, spectral energy distribution, and harmonic ratios. For further examples, see: “An Introduction to R Notes on R: A Programming Environment for Data Analysis and Graphics Version 4.4.2 (2024 Oct. 31),” by W. N. Venables, D. M. Smith.

In this disclosure, the term “machine learning model” is a program, often based on artificial neural networks (ANN), that can find patterns or make decisions from a previously unseen dataset. These can include supervised, unsupervised, and reinforcement learning. Examples of machine learning models include artificial intelligence, machine learning systems. and deep learning systems. Examples include but are not limited to Natural Language Processing Models (LLM), genetic algorithms, grid search, ensemble models, stacking, linear regression, support vector regression, Bayesian regression, k-nearest neighbors, decision trees, gradient boosting algorithms, and neural networks. See Russell and Norvig, “Artificial Intelligence, A Modern Approach, Fourth Edition,” Pearson, 2021, for further discussion and additional examples.

As previously discussed, at a high level, the invention can be viewed as a method or system for an automated method for time-series data analysis. Expressing the concept in methods terms, the overall concept is to use a time series-training dataset, at least one computer processor, and at least one static machine learning system to first (using the at least one computer processor) to automatically extract features from the time series dataset and then (using at least one static machine learning system,) and the extracted features, to automatically train at least one machine learning model, thus producing at least one trained machine learning model.

Here, the time-series training dataset comprises a linear array of time points starting from an origin time point, each time point having a single associated data point with a data point value. This represents the time series data that will be used to train the machine learning model.

The automatic feature extraction process works by using the at least one computer processor. Here, for at least some later time points (in some embodiments, all time points, and in others uniformly spaced time points) after the origin time point, using at least one sliding time window (usually of fixed time length) to create at least one (typically a plurality of) data subset(s). These data subsets represent that portion of the linear array covered by a given sliding time window.

Here, as discussed above, each at least one data subset comprises a portion of the linear array of time points and their associated data points over that particular (at least one) sliding time window.

Feature extraction: here, for each data subset, the method uses a plurality of different algorithms and the at least one computer processor to extract (individual, and algorithm specific) features from that data subset, thus producing a plurality of data subset individual feature vectors.

Vector fusion: here, for each data subset, the method fuses the plurality of data subset feature individual vectors together to produce a single data subset fused feature vector.

Training a machine learning model: here, the method uses a plurality of single data subset fused feature vectors, obtained over a plurality of different sliding time windows, as a machine-learning dataset. This machine-learning dataset and the at least one automated static machine learning system, are then used to automatically train at least one machine learning model, thus producing at least one trained machine learning model. This at least one trained machine learning model is then used to implement a time-series forecasting system.

Note that this application can be viewed as having two main parts. The first part is the feature extraction part, where the method uses a specific combination of known mathematical methods to extract features. This part is the preparatory step for the AI/ML model.

Once the features are extracted and fused, in the second part, they can be used to train the AI/ML model. In some embodiments, the invention may use automated machine learning to vary across various complex AI models and automatically tune their hyperparameters to find the one with the best metric. Then, this trained model can be used on new data to forecast future values by using the same feature extraction preparatory step to prepare new data points in the appropriate format

Thus, at a high level, the invention may include various steps such as:
Time-series data that contain single time-varying value with associated timestamps is used as input to the invention's feature extraction algorithm.
Using the dataset from the input, the feature extraction algorithm automatically extracts features from the time-series dataset
Extracted features are stored as a features vector describing each data point in time that now acts as target/label variable
Training dataset is prepared in tabular form with extracted features as inputs and time-series data points as targets for at least one static regression machine learning algorithms
Training is performed by using at least one automated machine learning procedure, varying over available regression algorithms and their hyperparameters to find the best model
User inputs time-series data to get the forecast
Feature extraction algorithm extracts features automatically and prepares inputs for the model
Pre-trained model provides forecasts or imputes missing data in the time-series dataset

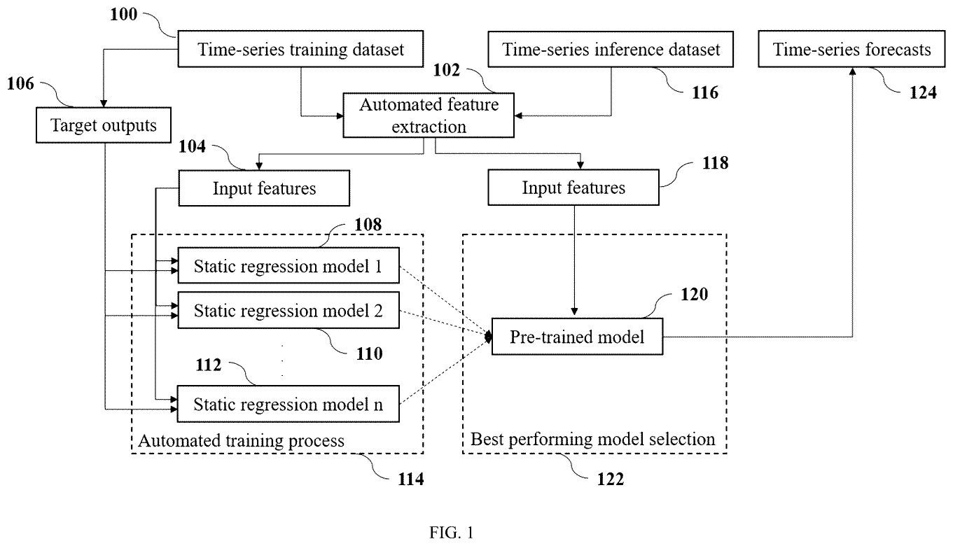

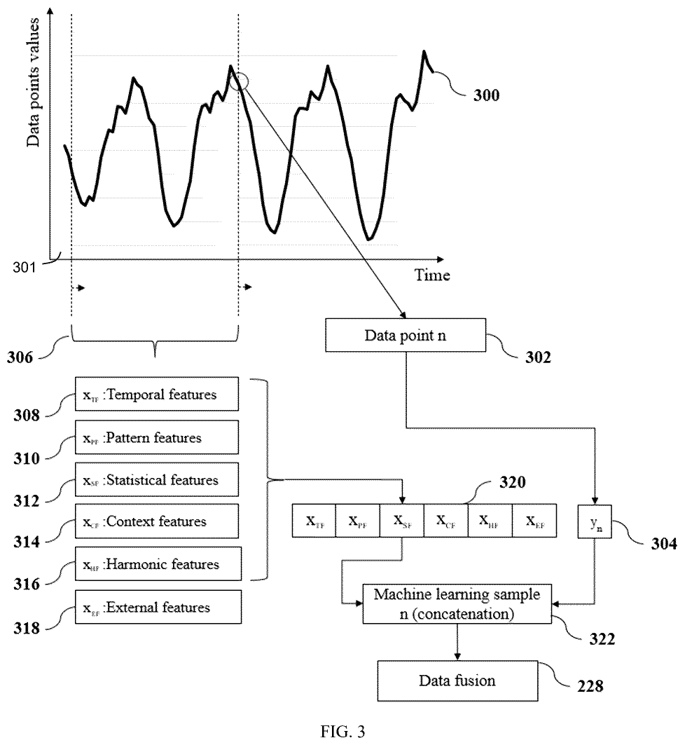

FIG. 1 shows the block diagram depicting the method of the invention described herein. The left-hand side of the figure describes the training process. Input data for the training of the method described herein is time-series dataset (FIG. 3, 300) that represents a single value time-stamped dataset 100. This dataset is forwarded to automated feature extraction block 102 (shown in more detail in FIG. 3) to automatically extract and form input features 104 for each data point, while each data point from the time-series training dataset is selected as target output 106.

In some embodiments, the automatic training process can proceed by running an automated machine learning process 114 that iterates over multiple static machine learning methods 108, 110, 112 and their hyperparameters. Here, a best performing model 122 is selected and deployed as a pre-trained model.

In some embodiments, the invention may further use new data (such as the time-series inference dataset 116) and the time-series forecasting system to make time-series forecasts based on this new data (116). This can sometimes be called an inference process.

The right-hand side of FIG. 1 shows inference process of the invention described herein. By using new data comprising the time-series inference dataset 116 and automated feature extraction in same manner like in training phase, input features 118 are created. By using these input features and pre-trained model 120 a time-series forecast 124 is made for each input features vector that is fed into a fully trained model (122).

Put alternatively, in some embodiments, the invention can use new data (116) and the time-series forecasting system to make time-series forecasts based on this new data by analyzing the new data (116, often by the same process used to create the original set of training data as per FIG. 3), and creating a plurality of new single data subset fused feature vectors (320) representing this new data. In this method, the time-series forecasting system uses the plurality of new single data subset fused feature vectors (320) representing this new data (116), and the trained machine learning model (120), to forecast future time series values (124).

Note that for the new data, the system does not have the target variable yₙ and it needs to forecast it. Otherwise, the rest of the time-series forecast process is much the same as previously discussed in FIG. 3. The system extracts features in the same way as it did in training (as explained in FIG. 1.), and sends the final features vector to the model and receives the next forecasted value. If we want to forecast further into the future, The system slides the sliding time window (306) to now include the new forecasted value as the final data point in the window and repeats the process to get the yₙ₊₁ value. The process is repeated to get more future data points.

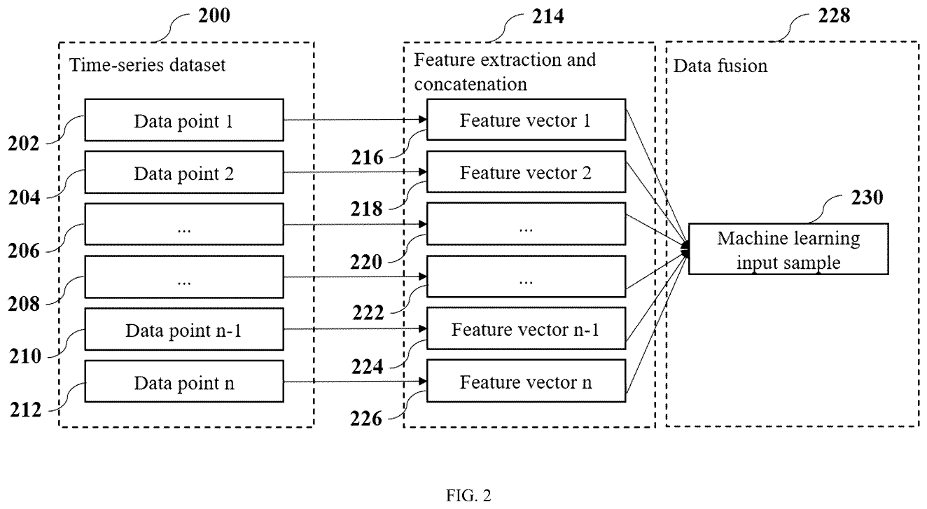

FIG. 2 shows further details of the automated feature extraction subroutine from the “Automated feature extraction” block (102) from FIG. 1.

Once time series dataset 200 (also shown as 300 in FIG. 3) is forwarded to this block (e.g. section of the system), each data point 202-212 from the input vector is decoupled and associated with its own feature vector in the feature extraction process 214 (data points from 1 202 to n 212 in FIG. 2). Once they are created, all feature vectors 216-226 (feature vectors from 1 216 to n 226 in FIG. 2) are fused/concatenated 228 in a unique machine learning input sample 230.

At a high level, these features can comprise any of temporal, pattern, statistical, context, harmonic, or external features. We will discuss these in more detail shortly.

At a more detailed level, these features are extracted by various data series analysis algorithms, including any of lagged values, moving averages, exponential moving averages, temporal differences, cumulative sums, time delta features, moving window replicated features, seasonality indicators, autocorrelation, local maxima, local minima, mean, median, standard deviation, variance, autocovariance, skewness, kurtosis, minimum values, maximum values, percentiles, interquartile ranges, energy, entropy, cross-entropy, time values, season values, binary indicators for events, time-frequency coefficients from Fourier and wavelet transforms, dominant frequencies, spectral energy distribution, and harmonic ratios.

How each feature vector from 1 216 to n 226 in FIG. 2 is created is shown in more detail in FIG. 3 where the block diagram depicting the feature vector generation subroutine for each data point in the automated feature extraction 214 subroutine is shown. Considering the example time series dataset 300 as shown in upper part of FIG. 3., each data point n can be described using, for example, five groups of features that are calculated from the previous sequence of datapoints.

Thus in FIG. 3, the data point n value 302 is extracted as the target value yₙ 304 while features are calculated using preceding data points 306 from the training dataset, by using the fixed width moving/sliding time window that slides over the time-series dataset for each data point (n, n+1, n+2). Here, the data represented by a given sliding window (306) can be termed a “data subset”, and an individual feature extracted by a given algorithm analyzing this data subset can be termed a “data subset individual feature vector.”

These features groups can include temporal features 308, pattern features 310, statistical features 312, context features 314, harmonic features 316 and external features 318, that are fused into single feature vector 320 (or data subset fused feature vector) as shown in FIG. 3. Put alternatively, the subset fused feature vectors are produced by concatenating the data subset feature individual vectors. Essentially, the smaller data subset individual feature vectors are essentially combined end-to-end to create a larger data subset fused feature vector. As the sliding time window (306) moves (in the analysis) a plurality of such larger data subset fused feature vectors are created, and these are used to train the machine learning algorithm.

Thus, the combination of feature vector n 320 and target value yₙ 304 presents one sample 322 for the static machine learning algorithm. For example, target value yₙ at time point n is described with set of features extracted from the preceding sliding time window. For next target value yₙ₊₁ at time point n+1 the time window shifts/slides for one time point and new set of features for yₙ₊₁ are calculated.

Note that in some embodiments, the at least one sliding time window is a plurality of incrementally sliding time windows, where each successive sliding time window advances by at least one time point over a proceeding sliding time window. Further, in some embodiments, each sliding time window has constant length per analyzed time-series dataset.

Note that as previously discussed, in some embodiments, the features further comprise feature types comprising any of temporal, pattern, statistical, context, harmonic, and external feature types. In some alternative schemes, the maximum length of the sliding time windows may vary according to those feature types being analyzed in a given time-series dataset.

Therefore, feature extraction from a time series dataset using a moving (sliding) time window preceding the target value yₙ involves generating descriptive features from the sequence of data points within the window. Let {y_{n-T}, y_{n-T+1}, . . . , yₙ} represent the time window of length T leading up to the target value yₙ. Feature vectors xᵢ are constructed by applying a set of mathematical operations or transformations to the values withing this window.

As previously discussed, the data fusion of extracted features can be done through data concatenation that involves combining multiple features vectors x_{TF}, x_{PF}, x_{SF}, x_{CF}, x_{HF}, x_{EF} into a single vector xₙ by appending them end-to-end along their dimensions. Mathematically, if xᵢ∈ [symbol] ^{d}^{ᵢ} di represents the i-th input vector of dimensions di, then the fused final vector xₙ∈ [symbol] ^{D} is obtained as

$${x}_{fused} = [ {x}_{1} ; {x}_{2} ; … ; {x}_{n} ] \\ where$$

$$D = {\sum }_{i = 1}^{n} {d}_{i}$$

and [;] denotes the concatenation operation. This method preserves the individual information of each vector while aligning them into a higher-dimensional feature space. Concatenation assumes that the final fused vector xₙ that provides unified representation of the input vectors without introducing redundancy or information loss, and it is typically used as input for downstream processes such as machine learning models or statistical analysis. For example, in FIG. 3 for any observation yₙ, the fused feature vector is defined by following equation:

$${x}_{n} = [ {x}_{TF} ; {x}_{PF} ; {x}_{SF} ; {x}_{CF} ; {x}_{HF} ; {x}_{EF} ]$$

where:
x_{TF}—Vector of size d_{tf} of temporal features
x_{PF}—Vector of size d_{pf} of pattern features
x_{SF}—Vector of size d_{sf} of statistical features
x_{CF}—Vector of size d_{cf} of context features
x_{HF}—Vector of size d_{hf} of harmonic features
x_{EF}—Vector of size d_{hf} of external features
xₙ—Final fused vector of size D, where D=d_{TF}+d_{PF}+d_{SF}+d_{CF}+d_{HF}+d_{EF}

The invention incorporates a comprehensive methodology for extracting and utilizing features from time series data, which are grouped into distinct categories based on their origin, role, and relationship to the target variable. These feature groups are automatically extracted from the fixed size moving time window (also called a sliding time window), by using the predefined hardcoded extraction routines as follows:

Regarding the previously discussed “temporal, pattern, statistical, context, harmonic, and external features.” Although each different specific algorithm can be used to create its own unique “feature type” with its own unique label, to help understand the process, it is useful to roughly categorize the large number of different feature extraction algorithms into a smaller number of overall categories. Thus, as a rough overview, where each descriptive section gives a summary of the various mathematical operations used to extract features:

Temporal features are derived from the sequential nature of time series data and are designed to capture dynamic changes and temporal dependencies within the dataset. These features include lagged values, which represent prior observations at various time steps, and moving averages or exponential moving averages, which smooth out short-term fluctuations to highlight longer-term trends. Temporal differences between consecutive or spaced observations provide insights into abrupt changes or trends, while cumulative sums over time windows reflect aggregated behavior. Time delta features measure the intervals between significant events, enabling the model to understand temporal spacing.

Pattern features focus on identifying recurring trends and behaviors within the time series data. These include sections of moving time window (i.e., sliding time window 306) used directly as features, but also seasonality indicators, which represent periodic fluctuations, and autocorrelation metrics that measure the correlation of a signal with itself over different lags. Other pattern features involve detecting local maxima and minima to identify peak behaviors, measuring the strength of underlying trends, and characterizing cycle durations and amplitudes. These features collectively allow the model to recognize structural patterns and cyclical behaviors inherent in the data.

Statistical features summarize the distribution of values within a defined time window (sliding time window). Key metrics include calculated values of mean, median, standard deviation and variance, autocovariance, but also higher-order statistics such as skewness and kurtosis, which describe asymmetry and tail heaviness. Minimum and maximum values, percentiles, and interquartile ranges provide additional context on the data's range and spread. Energy, entropy and cross-entropy calculations further quantify the overall magnitude and randomness of the data within the window.

Context features provide auxiliary information about the conditions or circumstances under which the time series data is generated. These include metadata such as the day of the week, time of day and season which capture periodic contextual variations. Binary indicators for special events, such as holidays or school days, are also included.

Harmonic features are derived from the frequency domain, capturing periodic and oscillatory behavior within the time series data. These features include coefficients from time-frequency analysis such as Fourier, short time Fourier, discrete Fourier, and wavelet transforms, which decompose the data into its frequency components. Metrics such as dominant frequencies, spectral energy distribution, and harmonic ratios provide detailed insights into the signal's cyclical nature. Harmonic features enable the model to incorporate both global and localized frequency-related behaviors.

Regarding external features, they refer to variables that are not part of the original dataset but provide additional context or important factors that can significantly improve the accuracy of a model. For example, in solar energy production forecasting, external features may include environmental variables such as temperature, solar insolation, wind speed, humidity, and cloud cover. In the case of cryptocurrency price prediction, external features can be features such as social media data, blockchain data, macroeconomic and microeconomic indicators, news data, gold and oil prices, stock market indices (e.g., S&P 500, NASDAQ), currency exchange rates, and transaction costs.

Methods and routines used for feature extraction can be standard mathematical tools (algorithms) that are available in various software packages (python, R, MATLAB). By following this approach, the time-series forecasting problem can be transferred from temporal space to features space enabling the utilization of static machine learning algorithms that are widely applicable and yielding good results with the feature extraction method described herein.

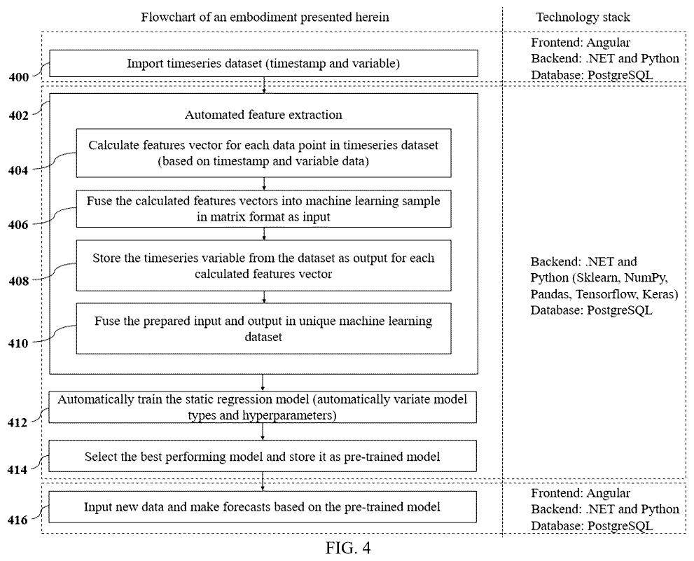

FIG. 4 presents a flowchart diagram showing a representation of the transaction flow, application of logic and examples of technology applied at each step of the invention described herein. General approach consists of importing of any time series dataset 400, where the automated feature extraction method 402 prepares the dataset for training (automated feature extraction block in FIG. 4). It starts with calculation of features vector for each data point 404, fusing of the calculated features vectors into machine learning samples 406, storing the timeseries variable as output 408 and finally fusing the prepared input samples and output variables into unique machine learning dataset 410. After that, the model is trained automatically 412, by choosing the best combination of hyperparameters and stores it as pre-trained model 414 that can be used to input new data and make accurate forecasts 416.

To use the method shown in FIG. 4, one only needs to import time series dataset (e.g. Microsoft NASDAQ historical stock index) and rest of the procedure will be performed automatically. New instances can be forecasted by using the deployed pre-trained model. The method is tested and compared to two industry-standard solutions for time series forecasting: Singular Spectrum Analysis (from ML.NET) and non-linear autoregressive neural network (from MATLAB). This test is performed on the Microsoft NASDAQ historical stock index. Testing results confirmed improved accuracy over standard methods in the following percentages: 91.64% better accuracy compared to the Singular Spectrum Analysis method and 48.67% better accuracy compared to the non-linear autoregressive neural network. Comparable improvements are obtained on other test datasets.

In some embodiments, the automated machine learning/training system for regression models may integrate with, and/or include, various advanced AI technologies, including but not limited to hyperparameter optimization algorithms such as Bayesian optimization, genetic algorithms, and grid search, ensemble models and stacking. The automated system is designed to process and analyze large datasets, automatically selecting and tuning regression models to achieve optimal predictive performance. For preprocessing, advanced data preparation techniques, including feature engineering, normalization, and dimensionality reduction via principal component analysis (PCA), may be employed to prepare the raw data for modeling. Once preprocessing is complete, the automated system employs a variety of regression algorithms, such as linear regression, support vector regression, Bayesian regression, k-nearest neighbors, decision trees, gradient boosting algorithms, and neural networks, to build multiple candidate models. These models undergo rigorous evaluation using cross-validation techniques to assess their performance on key metrics like mean squared error (MSE) and R-squared. Each selected model is further optimized through iterative hyperparameter tuning and ensemble methods to enhance accuracy and robustness. For our specific use case it will find the best AI/ML model for each dataset considering that some extracted features are useful and some not from case to case.

Put alternatively, in some embodiments, the invention may further use the at least one computer processor and the static machine learning system to automatically optimize which algorithms to use by automatically iterating over a plurality of different sets of different algorithms and automatically determining which sets of different algorithms produce a better-optimized machine learning model or time-series forecasting system.

1. An automated method for time-series data analysis of new data based on at least one time series-training dataset of previous datapoints, said method comprising:
using at least one time series-training dataset, at least one computer processor, and at least one static machine learning system comprising an artificial neural network (ANN), and a plurality of feature analysis algorithms to transform said time series-training data set to a static domain of features by automatically extracting features from said time series-training dataset;
wherein said at least one static machine learning system predicts a target variable based on said automatically extracted features irrespective of their temporal sequence in said dataset;
using said automatically extracted features to automatically train at least one machine learning model, thus producing at least one trained machine learning model;
wherein said time-series training dataset comprises a linear array of time points starting from an origin time point, each time point having a single associated data point with a data point value;
for at least some later time points after said origin time point, said at least one computer processor uses at least one sliding time window to create at least one data subset, each at least one said data subset comprising a portion of said linear array of time points and their associated data points over that said at least one sliding time window;
for each said data subset, using said at least one static machine learning system comprising an artificial neural network (ANN), a plurality of feature analysis algorithms and said at least one computer processor to automatically extract features from that data subset, thus producing a plurality of data subset individual feature vectors;
for each said data subset, fusing said plurality of data subset individual feature vectors by concatenation to produce a single data subset fused feature vector, thus preserving the individual information of each said individual feature vector while aligning them into a higher-dimensional feature space;
using a plurality of single data subset fused feature vectors, obtained over a plurality of different sliding time windows, as a machine-learning dataset; and
using said machine-learning dataset and said at least one static machine learning system, to automatically train at least one said machine learning model, producing at least one trained machine learning model for forecasting future time series values; and
using at least one said trained machine learning model for forecasting future time series values to implement a time-series forecasting system for new data by the steps of;
analyzing said new data by using said at least one static machine learning model to create a plurality of new single data subset fused feature vectors representing said new data;
wherein said time-series forecasting system uses said plurality of new single data subset fused feature vectors representing said new data, and said trained machine learning model for forecasting future time series values, to forecast future time series values.

2. (canceled)

3. (canceled)

4. The method of claim 1, wherein said features extracted by said feature analysis algorithms comprise any of temporal, pattern, statistical, context, harmonic, and external features.

5. The method of claim 1, wherein said feature analysis algorithms comprise any of lagged values, moving averages, exponential moving averages, temporal differences, cumulative sums, time delta features, moving window replicated features, seasonality indicators, autocorrelation, local maxima, local minima, mean, median, standard deviation, variance, autocovariance, skewness, kurtosis, minimum values, maximum values, percentiles, interquartile ranges, energy, entropy, cross-entropy, time values, season values, binary indicators for events, time-frequency coefficients from Fourier and wavelet transforms, dominant frequencies, spectral energy distribution, and harmonic ratios.

6. (canceled)

7. The method of claim 1, wherein said at least one sliding time window sliding time window used to create at least one data subset, each at least one said data subset comprising a portion of said linear array of time points, is a plurality of incrementally sliding time windows, where each successive sliding time window advances by at least one time point over a proceeding sliding time window.

8. The method of claim 1, wherein said sliding time window sliding time window to create at least one data subset, each at least one said data subset comprising a portion of said linear array of time points has constant length per analyzed time-series dataset.

9. The method of claim 1, wherein said features further comprise feature types comprising any of temporal, pattern, statistical, context, harmonic, and external feature types, further varying a maximum length of said sliding time windows according to said feature types per analyzed time-series dataset.

10. The method of claim 1, wherein said at least one static machine learning system used to automatically extract features from said time series-training dataset is selected from any of a Sklearn, ML.NET, TensorFlow, Keras, PyTorch, XGBoost, CatBoost or other deep learning system.

11. The method of claim 1, wherein using said static machine learning system to automatically train either said machine learning model or said time-series forecasting system by using any of genetic algorithms, grid search, ensemble models, stacking, linear regression, support vector regression, Bayesian regression, k-nearest neighbors, decision trees, gradient boosting algorithms, and neural networks to automatically extract features from said time series-training dataset, thus creating a plurality of data subset individual feature vectors used to build said machine learning model and said time-series forecasting system; and
wherein said static machine learning system further optimizes either said machine learning model or said time-series forecasting system using any of a mean squared error (MSE) or other error metrics through any of iterative hyperparameter tuning and ensemble methods.

12. The method of claim 11, further using said at least one computer processor and said static machine learning system to automatically optimize said algorithms by automatically iterating over a plurality of different sets of feature analysis algorithms and automatically determining which sets of feature analysis algorithms produce a better-optimized machine learning model or time-series forecasting system.
